(19) United States
(12) Patent Application Publication
(10) Pub. No.: US 2026/0203123 A1
(43) Pub. Date: Jul. 16, 2026

(54) CREATOR INTELLIGENCE FOR OPERATORS

(71) Applicant: INTERNATIONAL BUSINESS MACHINES CORPORATION, Armonk, NY (US)

(72) Inventors: Zhi Li GUAN, Beijing (CN); Shi SU, Beijing (CN); Guo Liang HUANG, Beijing (CN); Hai Wei FANG, Tianjin (CN); Yun DIAO, Beijing (CN); Fang Tai LI, Beijing (CN)

(21) Appl. No.: 19/020,606

(22) Filed: Jan. 14, 2025

(51) Int. Cl. G06F 9/50; G06F 9/54

(52) U.S. Cl. CPC G06F 9/5033; G06F 9/541

(57) ABSTRACT

Computer-implemented methods, computer program products, and computer systems include program code obtaining a request to generate a resource. The program code utilizes an operator to create the resource. The program code enhances the resource by appending information identifying a creator of the resource to an API request to deploy the resource. The program code mutates an object definition of the resource to add the information identifying the creator of the resource to the object definition of the resource. The program code deploys the resource with the mutated object definition.

### BACKGROUND

One or more aspects relate, in general, to facilitating continuation of services within a computing environment, and in particular, to identifying resource and process owners to mitigate issues with the computing environment, including in multiple tenant software as a service (SaaS) environment computing environments.

A container image is a software package that includes the software to be used to run an application, including, for example, code, application and system libraries and runtime default settings. The size of container images continues to grow larger, and some are several gigabytes in size. A change, including a slight change, in configuration requires a different image, and at times, there are requirements to dynamically change the components in the image.

### SUMMARY

Shortcomings of the prior art are overcome, and additional advantages are provided through the provision of a computer-implemented method of facilitating operator management in a multi-tenant environment. The computer-implemented method includes obtaining, by one or more processors, based on a user creating a custom resource, a request to generate a resource. The method includes utilizing an operator to create the resource. The method includes enhancing the resource, wherein the enhancing comprises: appending, by the one or more processors, information identifying a creator of the resource to an API request to deploy the resource. The method includes based on the appending, mutating an object definition of the resource to add the information identifying the creator of the resource to the object definition of the resource. The method includes deploying the resource with the mutated object definition.

Shortcomings of the prior art are overcome, and additional advantages are provided through the provision of a computer program product for facilitating operator management in a multi-tenant environment. The computer program product comprises a storage medium readable by one or more processors and storing instructions for execution by the one or more processors for performing a method. The method includes, for instance, obtaining, by the one or more processors, based on a user creating a custom resource, a request to generate a resource. The method includes utilizing an operator to create the resource. The method includes enhancing the resource, wherein the enhancing comprises: appending, by the one or more processors, information identifying a creator of the resource to an API request to deploy the resource. The method includes based on the appending, mutating an object definition of the resource to add the information identifying the creator of the resource to the object definition of the resource. The method includes deploying the resource with the mutated object definition.

Shortcomings of the prior art are overcome, and additional advantages are provided through the provision of a computer system for facilitating operator management in a multi-tenant environment. The system includes: a memory, one or more processors in communication with the memory, and program instructions executable by the one or more processors via the memory to perform a method. The method includes obtaining, by the one or more processors, based on a user creating a custom resource, a request to generate a resource. The method includes utilizing an operator to create the resource. The method includes enhancing the resource, wherein the enhancing comprises: appending, by the one or more processors, information identifying a creator of the resource to an API request to deploy the resource. The method includes based on the appending, mutating an object definition of the resource to add the information identifying the creator of the resource to the object definition of the resource. The method includes deploying the resource with the mutated object definition.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present invention;

FIG. 2 depicts one example of a node, in accordance with one or more aspects of the present invention;

FIG. 3 illustrates an operator in a platform in a multi-tenant environment that provides software as a service (SaaS);

FIG. 4 illustrates a group of operators and their ownership versus creatorship relationships in an implementation in a computing system;

FIG. 5 depicts one example of a technical environment in which various aspects of the examples herein have been implemented in order to practice the workflows of FIGS. 6-8;

FIG. 6 depicts a workflow of which various aspects can be implemented in a multi-tenant environment in accordance with aspects of the present disclosure;

FIG. 7 depicts a workflow of which various aspects can be implemented in a multi-tenant environment in accordance with aspects of the present disclosure; and

FIG. 8 depicts a workflow of which various aspects can be implemented in a multi-tenant environment in accordance with aspects of the present disclosure.

### DETAILED DESCRIPTION

In accordance with one or more aspects, a capability is provided to facilitate operator tracking in multiple tenant SaaS environments, which extends resource management capabilities in these environments. In the examples herein, operator information is enhanced (e.g., via meta data), without interfering with existing meta data-based resources mechanism, to add creator information. Adding these data aids process and resource management within the computing environment because this addition enables program code executed by one or more processors to identify a creator chain and relationship for a given resource. Using current approaches and implementations, creator information is often missing and the absence of this information complicates troubleshooting, especially in large enterprise application deployments.

The operator enhancements described herein serve to facilitate processing within a computing environment. A non-limiting example of a platform that can be enhanced through the utilization of the examples described herein is Kubernetes®, which is an open-source, extensible, portable container management platform. Kubernetes is a registered trademark of The Linux Foundation, San Francisco, CA. Other platforms may also be used. In Kubernetes, for example, a container has its own central processing unit share, filesystem, process space, memory and more. Further, containers may share the operating system (OS) among applications due to their relaxed isolation properties; containers are decoupled from the underlying infrastructure; containers are portable across operating system distributions and clouds; and each container is repeatable. Containers are intended to be stateless and immutable—code of a running container is not to be changed; instead, a new container image is built to include the change. Containers in Kubernetes, as well as containers in other platforms, can be isolated from each other as well as from the underlying infrastructure, into separate namespaces that are managed by operators. An operator is a software extension (e.g., in Kubernetes) that makes use of custom resources to manage applications and their components.

In computing environments, custom objects, which can be referred to as operators, can execute on pods in resource clusters and interface with application programming interface (API) servers to access containers, which the operators can deploy to resources comprising the pods. Each tenant in a multi-tenant environment (e.g., cloud computing environment) can have its own namespace and this namespace will be controlled by a single operator. Namespace-level tenancy is a configuration that isolates tenants on the same cluster using namespaces. However, a multi-tenant SaaS application is a type of software architecture that allows multiple users or tenants to access and use the same instance of an application simultaneously. Operators are primary interfaces for a user in Kubernetes, they are consistent with the resource-based interaction model on the Kubernetes cluster. Operators create objects based on a custom resource (a customization of an installation).

In certain multiple tenant SaaS environments, such as Kubernetes, some objects are the owners of other objects. In a non-limiting example specific to Kubernetes, a ReplicaSet (RS), a Kubernetes object used to maintain a stable set of replicated pods running within a cluster at any given time, can be an owner of a set of pods (smallest deployable units of computing that can be utilized in systems management). The owned objects are therefore dependent on the owner object and these dependent objects. Dependent objects can include metadata that references their owner object. In the Kubernetes example, a valid owner reference would consist of the object name and a unique identifier with the same namespace as the dependent object. In this framework, the creator information of an enterprise application (e.g., deployed by Kubernetes Operator Creator) can be important to an operator because when an unexpected issue occurs, it can be difficult to troubleshoot when the origin of the object is unknown and hence, who updates and created the object. It is possible that a configuration map would have an incorrect setting and when this is the case, presently, a user and/or process cannot determine from the enterprise application itself (or other resource), how to address the issue because the creator and manager is unknown. The configuration map can be unreliable itself based on not knowing who creates and managed the configuration map.

In order to enhance resource data with creator information, in accordance with the examples herein, examples herein can include the following: 1) a framework to support intelligent identification and add the creator information into this framework; 2) an extended client (e.g., a Kubernetes client) to automatically identify creator information and send it as additional options to an application programming interface (API) server; 3) enabling custom logic to change aspects of a resource before it is created or updated within a cluster (e.g., a mutating webhook to an API server); and/or 4) an enhanced interface that displays creator information in a (e.g., Kubernetes) console so a user can link to the related object.

In some of the examples herein, program code executing on one or more processors can define the framework to support intelligent identification and add the creator information into this framework. This defined framework can include a creator section to operator information and utilize this section to track and save creator information. Program code can also store creator information using a unified label format.

In some of the examples herein, extending the client to automatically identify creator information and send it as additional options to an API server can include setting an environment variable of the operator deployment name. The program code that deploys operators within the computing environment can deploy the operator with this set environment variable (e.g., “OPERATOR_NAME”). In these examples, the client package can read the environment variable and automatically add it as additional parameter when operator code creates a resource through the client package.

In some of the examples herein, program code of the custom logic, which can be understood as program code of a mutating webhook, can: 1) extract creator information from additional parameters based on a client request; 2) add the creator information to an object; 3) send the updated object to an API server; and 4) adds this creator information without interfering with other aspects of the framework (e.g., a Kubernetes framework). In some examples, the API server can be a Kubernetes API server (e.g., kube api-server). A Kubernetes API executes program code that can query and manipulate the states of objects in a Kubernetes framework and is thus considered a control plane of Kubernetes, together with an HTTP API that it exposes. A Kubernetes API server acts as a hub for communications throughout clusters and with external components.

The examples herein are inextricably tied to computing and are directed to a practical application. A challenge unique to computing is maintaining processing continuity in multiple tenant SaaS environments. The complexity of these types of environments provides challenges in troubleshooting issues as there are challenges identifying control mechanisms for a resource providing unexpected, inconsistent, or otherwise problematic results are not always readily apparent. A known issue, for example, in a Kubernetes environment is being able to identify, after an unexpected event involving a resource, the creator and/or maintainer of that resource. By being able to identify the creator and/or maintainer of the resource, a user or process can more quickly mitigate the issue. In a multi-tenant environment, this identification can be additionally complex. The examples herein address a specific known issue in a technical environment by providing a solution that modifies aspects of the technical framework and/or resources, including the architectural aspects of the system. Thus, the examples herein are inextricably computing because they address an issue unique to computing environments and introduce modifications to computing objects to address this issue.

The examples herein provide significantly more than existing approaches to implementing troubleshooting data in aspects of multiple tenant SaaS environments to maintain processing continuity. Unlike certain existing approaches, some examples herein provide a mechanism for identifying owners of objects and resources in workloads. Certain examples herein also disclose identifying a creator of an activity in a multiple tenant SaaS environment (e.g., Kubernetes) as well as tracking this creator. Some examples herein disclose a resource creator intelligent tracking for operators.

The examples herein include computer-implemented methods, computer program products, and computer systems which increase efficiencies and business continuity in complex computing environments by making information that is utilized to maintain these efficiencies and continuities readily available. The examples herein, as noted earlier, are inextricably tied to computing and provide significantly more than existing approaches to the practical application of increase efficiencies and business continuity specifically based in making the creator of objects and resources within the computing environment readily identifiable.

In some examples, program code executing on one or more processors obtains, based on a user creating a custom resource, a request to generate a resource. The program code utilizes an operator to create the resource. The program code enhances the resource by appending information identifying a creator of the resource to an API request to deploy the resource. Based on the this enhancement, the program code mutates an object definition of the resource to add the information identifying the creator of the resource to the object definition of the resource. The program code deploys the resource with the mutated object definition. The availability of this information, provided in a manner that does not interfere with the existing framework, is inextricably tied to computing because the creator information can assist in troubleshooting issues within the computing system. Applying this aspect to trouble shooting evidences its practical application. The existing framework does not make this information readily or automatically available and hence, this aspect is a significant improvement,

[symbol]

In some examples, appending the information identifying the creator of the resource to the API request comprises: program code reading an environment variable of a node of the user. The program code can also generate an options variable based on the environment variable. This aspect is inextricably ties to computing as it enhances metadata within computing objects in order to automatically provide additional information (hence also directed to a practical application). By utilizing environmental variables to add and persist these data, this approach works within existing frameworks.

In some examples, the environment variable comprises an operator deployment name. By integrating the creator into an operator deployment name, the examples herein can enable information about a creator to persist in a consistent manner throughout the lifecycle of a deployment and upon re-deployment of a resource. This continuity and consistency helps maintain efficiencies within the computing system

In some examples, the program code deploys the resource with the operator deployment name. Deploying this information enables it to be readily accessed and utilized for troubleshooting which increases the usability of the computing system as a whole.

In some examples, mutating the object definition of the resource comprises: the program code obtaining, at an API handler of an API server, the API request with the appended information. The program code authenticates, at the API server, the API request. The program code utilizes a webhook to mutate the object definition. The program code persists the mutated object definition to a key value store. Webhooks enables the interception of an object during a process to implement a change that does not adversely affect any other functionality. By utilizing a webhook, the practical application, providing these data moving forward, is handled using a mechanism that is inextricably tied to computing.

In some examples, the program code deploying the resource with the mutated object definition comprises utilizing the key value store. This approach provides significantly more than existing approaches because by implementing these data on a server-side, the API server can continue to deploy resources that include these data.

In some examples, the program code enforces a CR state of the resource. In these examples, before the CR state is enforced, the resource and the request for the resource are altered to include creator information. Thus, this aspect enables the preservation of these data moving forward so that various applications that communicate with the resource can obtain this information. As the system is interconnected, the availability of these data from the resource can assist in maintaining efficiencies throughout the system as a while.

In some examples, the program code displays the information identifying the creator of the resource in a user interface. This aspect provides significantly more because it allows a user to transparently understand the relationships between resources in a complex system and to trace issues more easily based on understanding these relationships.

In some examples, the program code determines that an unexpected event occurred involving the resource. The program code accesses the information identifying the creator of the resource. The program code troubleshoots the unexpected event, wherein the troubleshooting comprises querying the creator of the resource. Troubleshooting computer-related issues is a practical application that is inextricably tied to computing. This aspect of the examples herein is directed to improving troubleshooting by providing data that can trace issues.

In some examples, the program code continuously tracks the request to generate the resource. By tracking the request, the program code can automatically provide information, including enhanced information, about a resource, which assists in maintaining efficiencies within the computing system.

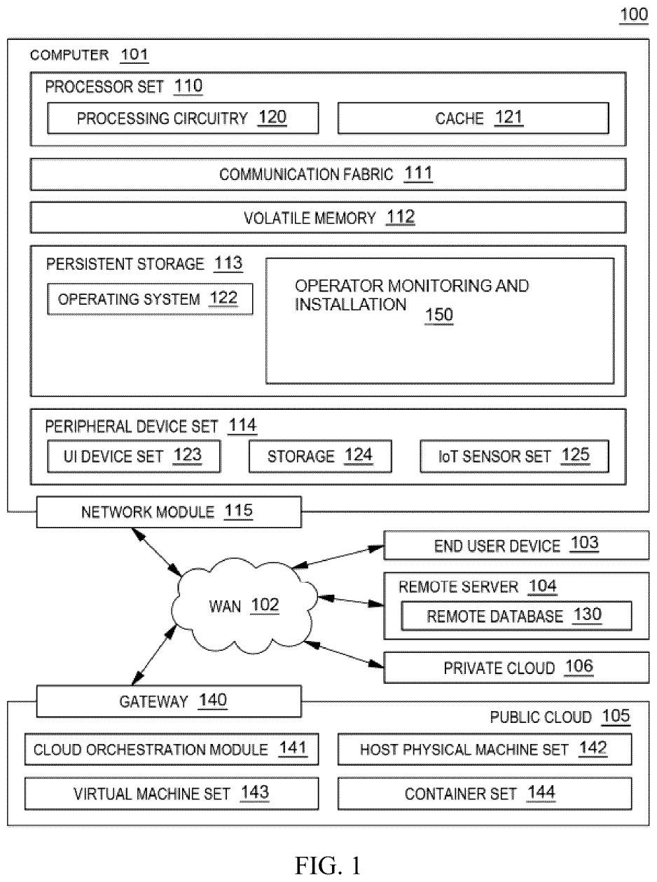

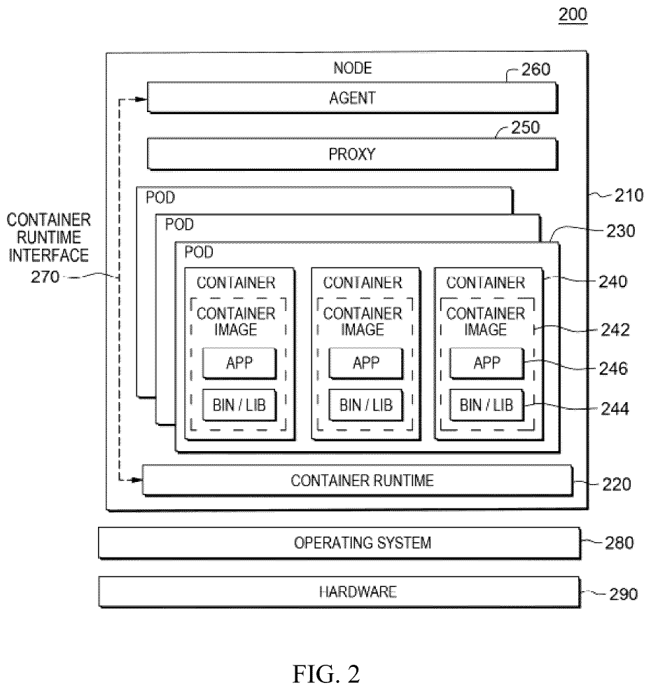

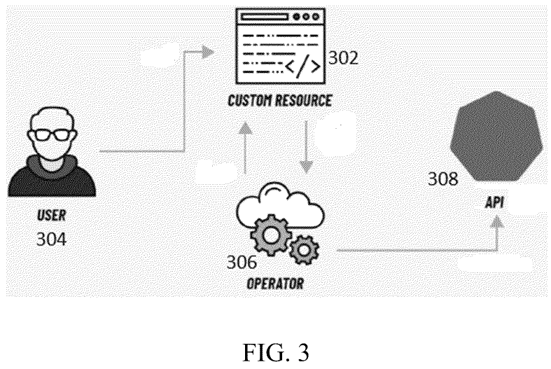

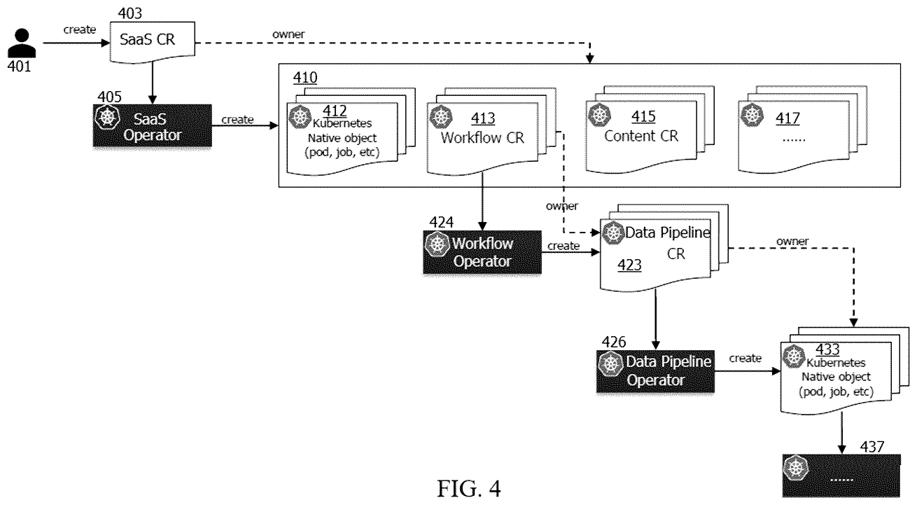

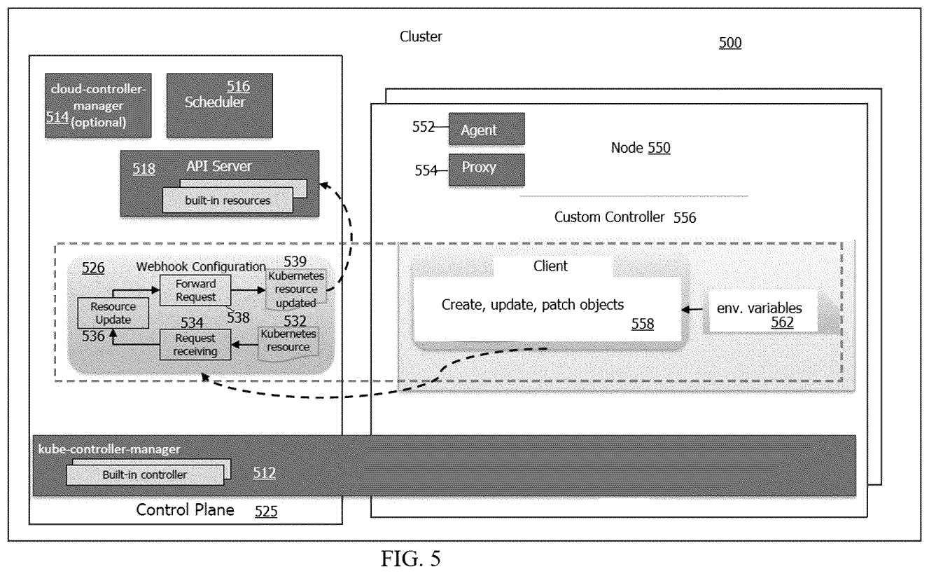

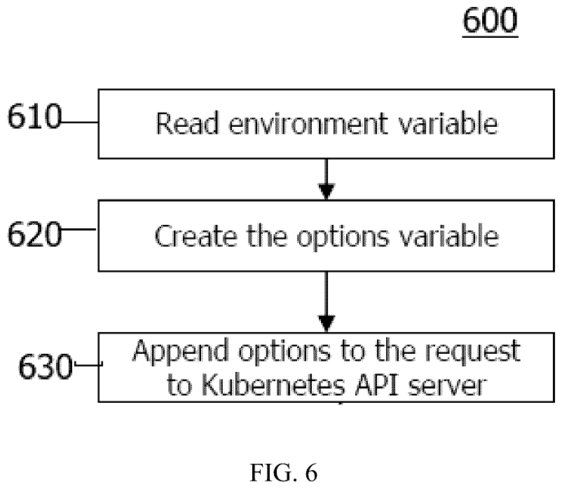

Computing environments, including computing environment 100 example illustrated in FIG. 1 support containers utilized in Kubernetes and in other computing platforms. The containers may be provided in a cloud, such as a public cloud (e.g., public cloud 105), a private cloud (e.g., private cloud 106), a hybrid cloud and/or on-premises (e.g., computer 101). In one example, containers are managed by one or more of various management platforms. One example of such a platform is Kubernetes but other platforms may also be used. Further details regarding architectures that include platforms and containers are described with reference to FIG. 2. Both FIGS. 1 and 2 are described in greater detail herein. Meanwhile, FIG. 3 illustrates an operator 306 in a platform in a multi-tenant environment that employs SaaS. FIG. 4 illustrates a group of operators and their ownership versus creatorship relationships in an implementation in a computing system. FIG. 5 depicts one example of a technical environment in which various aspects of the examples herein have been implemented in order to practice the workflows of FIGS. 6-8.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 1. In one example, computing environment 100 contains an example of an environment for the execution of at least some of the computer code involved in performing the inventive methods, such as implementing troubleshooting data in aspects of a multiple tenant SaaS environment to maintain processing continuity 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

In one example, the computing environment 100 supports containers. The containers may be provided in a cloud, such as a public cloud (e.g., public cloud 105), a private cloud (e.g., private cloud 106), a hybrid cloud and/or on-premises (e.g., computer 101). In one example, containers are managed by one or more of various management platforms, such as Kubernetes, for example, in which a container has its own central processing unit share, filesystem, process space, memory and more. These containers may share the operating system (OS) among applications due to their relaxed isolation properties; containers are decoupled from the underlying infrastructure; containers are portable across operating system distributions and clouds; and each container is repeatable. Containers are intended to be stateless and immutable—code of a running container is not to be changed; instead, a new container image is built to include the change. Further details regarding containers are described with reference to FIG. 2.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

As indicated earlier, in at least one example, computing environment 100 supports containers. The containers may be provided in a cloud, such as a public cloud (e.g., public cloud 105), a private cloud (e.g., private cloud 106), a hybrid cloud and/or on-premises (e.g., computer 101). In one example, containers are managed by one or more of various management platforms and one example of such a platform is Kubernetes^{.} Further details regarding containers are described with reference to FIG. 2.

In one example, referring to FIG. 2, a computing environment 200 includes one or more nodes 210, an operating system 280 shared by the one or more nodes, and underlying hardware 290, such as processing units, etc. used by the one or more nodes. The nodes may be virtual or physical machines, and they may be on-premise (e.g., in computer 101 and/or other computing devices) and/or in a cloud environment (e.g., public cloud 105, private cloud 106, a hybrid cloud environment and/or other cloud environment). In one example, computing environment 200 employs a platform, such as Kubernetes and/or another platform, to manage the containers. Kubernetes is a platform for running and managing containers from a plurality of container runtimes, including, but not limited to, Docker®, containerd®, Container Runtime Interface-Open Container Initiative (CRI-O), etc. Although examples of platforms and runtimes are provided, additional, fewer and/or other platforms and/or runtimes may be used. Docker is a registered trademark of Docker, Inc., San Francisco, CA; and containerd is a registered trademark of The Linux Foundation, San Francisco, CA.

In one example, a node 210 includes a container runtime 220, such as, for instance, Docker, containerd, Container Runtime Interface-Open Container Initiative (CRI-O), etc.; one or more pods 230; a proxy 250; and an agent 260. One example of proxy 250 is a kube-proxy, which is a network proxy that runs on each node in a cluster, implementing part of the Kubernetes Service concept. A kube-proxy maintains network rules on the nodes, and these network rules allow network communication to the pods from network sessions inside or outside of the cluster. One example of agent 260 is a kubelet that runs on each node. It can register the node, using one or more of a hostname, flag or other, with an application programming interface (API) server that validates and configures data for objects (e.g., pods). In other examples in which the platform is other than Kubernetes, the proxy and agent may be for that platform. Many examples are possible.

In one example, a container runtime interface 270 is provided, which is a plugin interface that enables agent 260 (e.g., the kubelet) to use a wide variety of container runtimes (e.g., container runtime 220) without having to recompile the cluster components.

In one example, a pod 230 includes one or more containers 240, and a container 240 includes, for instance, a container image 242 having one or more applications 246 with one or more libraries 244, and/or one or more binary and/or text resources. A container image is deployed on the node (e.g., node 210), as described herein.

In accordance with one or more aspects, deployment of a container image (e.g., container image 242) is facilitated, reducing and stabilizing the size of the image. In one or more aspects, a container image deployment module is used to deploy container images, at runtime. A container image deployment module includes code or instructions used to perform container image deployment, in accordance with one or more aspects of the present invention. A container image deployment module includes, in one example, various sub-modules to be used to perform the processing. The sub-modules are, e.g., computer readable program code (e.g., instructions) in computer readable media, e.g., storage (storage 124, persistent storage 113, cache 121, other storage, as examples). The computer readable media may be part of a computer program product and the computer readable program code may be executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computers, servers, processors, nodes, processing circuitry and/or other computing devices may be used to execute one or more of the sub-modules and/or portions thereof. Many examples are possible.

As noted above, FIG. 3 illustrates an operator 306 in a platform in a multi-tenant environment that employs SaaS. FIG. 3 illustrates a CR 302 in a multi-tenant environment that is accessed by a user 304 and managed by an operator 306, which connects to the platform's API server 308 (e.g., Kubernetes API server). The operator 306 is comprised of program code executed by one or more processors that is running in a pod on a cluster, interacting with the (e.g., Kubernetes) API server 308. A non-limiting example of muti-tenant (e.g., cloud computing) environment into which operators can be utilized as illustrated in FIG. 3 is IBM Cloud Pak for Business Automation (IBM CP4BA) as a service. IBM Cloud Pak for Business Automation as a service (IBM CP4BA service) is a modular set of integrated software components, built and designed to automate work and accelerate business growth. The program code comprising the operator 306 can introduce new object types through CRDs, which is an extension mechanism for various platforms, including in Kubernetes. The custom objects provided by the operator 306, which are accessible via the CR 302, are a primary interface for a user 304 to the CR 302. The software of the SaaS is embodied in this custom object provided to the user 304 and deployed using the operator 306. A user 304 can access the software deployed by the operator 306 and modify the CR 302. The operator 306 monitors the CR 302 and obtains, via the CR 302, any change events. The operator 306 can adjust the state of the API server 308 based on the change events obtained via the CR 302.

As discussed above, objects in a multi-tenant environment, such as Kubernetes objects, can own each other, but separately, each object can have a creator that can be different from the owner. FIG. 4 illustrates a group of operators and their ownership versus creatorship relationships in an implementation in a computing system. FIG. 4 uses the example of a Kubernetes operator where all custom resource (CR) related objects are created by the operator. FIG. 4 illustrates that there is a complex relationship among operators creating a cascade (model) for object creation where, in existing approached, creator information is lost. Initially, a SaaS environment 403 (an automated set of components) is created by a user 401, and the SaaS operator 405 creates various other components 410, including a Kubernetes (non-limiting example) native object 412, a workflow CR 413, a content CR 415, and additional others CRs 417. The SaaS CR 403 can be the owner of the components 410. However, the SaaS operator 405 is the creator of the components 410. The workflow CR 413 creates a workflow operator 424, which creates a data pipeline CR 423. Meanwhile, the workflow CR can own the data pipeline CR 423. This data pipeline CR can own a Kubernetes native object 422, which itself can create additional operators 437. The data pipeline CR can create a data pipeline operator 426, which creates the Kubernetes native object 422. Thus, the owners and creators are not always straightforward and as aforementioned, the creator (of the resource) information can be lost.

Creator information in enterprise applications deployed by an operator (e.g., a Kubernetes operator), is helpful to maintain consistent functionality and processing through a SaaS environment. Without creator information, when an unexpected issue happens, it is difficult to identify who (e.g., operator or customer) created or updates the resources that are potentially related to the issue. For example, a configmap (configuration map) can have the wrong settings and the user will be unable to determine who manages or creates the configmap. Another example is that a pod can fail during the deployment of an automated software platform (including but not limited to IBM® Cloud Pak for Business Automation (CP4BA)). Customer support, whether human or automated, will be unable to determine the creator of the resource of the pod and hence, will be unable to identify whether the corresponding operator related task failed. In another example, a pod could fail to start and the root cause is the pre-task object creator failure in the related operator, but from the perspective of the pod, neither the end user nor the support team knows where to look to find the creator of the resource.

The computer-implemented method, computers program products, and computer systems described herein comprise program code executing on one or more processors that extends resource management in an SaaS environment (including in a cloud computing environment), by adding creator data to the existing infrastructure, including through the addition of creator meta data. Because this information is available in the examples herein, a creator chain and resource relationships can be identified within the SaaS environment. To enable this functionality, first, the program code defines a framework to support intelligent identification and adds the creator (of the resource) information. The program code can extend resource management by adding a creator section for use in tracking and saving creator information. The program code can store the creator information using unified label format. Second, the program code can extend the (e.g., Kubernetes) client to automatically identify the creator information and send it as additional options to an API server. As such, the program code can set an environment variable of the operator deployment name. The program code then deploys the operator with a set environment variable, e.g., “OPERATOR_NAME”. The program code of the client package can read the environment variable and automatically add it as additional parameter when operator code creates a resource through the client package. Third, the program code can add a mutating webhook to an API server. The program code of the mutating webhook can extract creator information from the additional parameters from a client request. The program code can also add creator information to an object. The program code can then send the updated object to the API server. Hence, creator information is added without disrupting the existing framework. Finally, the program code can enhance a user interface by displaying creator information in a console so a user can link to the related object easily.

FIG. 5 illustrates a cluster 500, in this non-limiting example, a Kubernetes cluster, where aspects of the examples herein can be implemented. The cluster 500 includes elements which were described in FIG. 2. However, included herein is a control plane 525 and one or more nodes 550. Program code comprising a controller 512 controls the nodes 550. The control place 525 can optionally include a cloud controller manager 514 and a scheduler 516. Additionally, the control plane 525 includes the webhook configuration 526, wherein the program code receives a resource 532, upon requesting the resource 534, updates the resource 536, forwards the request 538, and updates the resource 539, providing it to an API server 518. On the node 550 side, which is illustrated also as node 200 in FIG. 2, an agent 552 (FIGS. 2, 260) and a proxy 554 (FIGS. 2, 250) reside, and the node 550 is managed by an operator custom controller 556 which executed a client 558, which obtains environmental variable 562 and can create, patch, and update objects.

As aforementioned, program code in the examples herein can extend a client package (to include creator information). A package client can contain functionality for interacting with PI servers. Clients can be readers or writers. Readers get and list, while writers create, update, and delete. These options are supported in various technical environments as arguments at the end of method calls. Thus, program code can utilize a method call to label a selector on a list. Below are examples of pseudocode that can be utilized by program code in the examples herein.

To create, delete, and update objects:
typeWriterinterface{

Using create can save an object in a cluster. However, in order to update the object within the content return by a server, the program code creates a structural pointer:
Create(ctxcontext. Context, objObject, opts . . . CreateOption) error
The program code can delete an object from a cluster:
Delete(ctxcontext. Context, objObject, opts . . . DeleteOption) error

The program code can update and object in a cluster, IN this example, the object is a structural pointed so that it can be updated with the content returned by the Server:
Update(ctxcontext. Context, objObject, opts . . . UpdateOption) error

The program code can patch an object in a cluster; this object is a structural pointer so that it can be updated with the content returned by the Server:
Patch(ctxcontext. Context, objObject, patchPatch, opts . . . PatchOption) error
The program code can delete all objects of a given type matching given options:
DeleteAllOf(ctxcontext. Context, objObject, opts . . . DeleteAllOfOption) error

In the examples herein, program code executing on one or more processors can extend a client package. The program code can set an environment variable to a deployment specification and then extend the client package by reading the environment package and then adding additional options. Specifically, the program code can append options to a request to an API server. As illustrated in the workflow 600 of FIG. 6, program code executing on one or more processors can read an environment variable (610), create an options variable (620), and append the options to a request to an API server (630). Hence, the client can be deployed with the options.

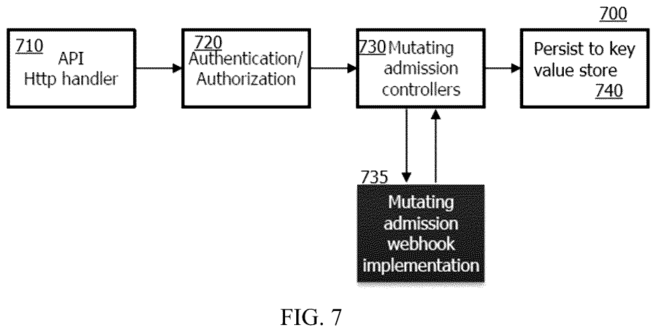

FIG. 7 illustrates a workflow 700 related to implementation of a webhook in the examples herein. As illustrated in FIG. 7, ultimately, the program code persists changes to a key value store (740), which is a backing store for cluster data in a SaaS framework. In a Kubernetes environment, the key value store is ETCD. In this examples, the API handler passes data (e.g., a resource, object) (710) to an authentication or authorization process (720), which passes data to mutating admission controllers to mutate these data (730), including by implementing a mutating admission webhook (735). Once the mutations are implemented by the program code, the program code persists the mutations to the key value store (740). Hence, the API can deploy a resource with updates. The webhook enables the program code to save an object with creator information. Below is an example of object information after it has been modified utilizing the webhook. This example is a Kubernetes-based example and is non-limiting and offered for illustrative purposes only. But note that the sample saved object (reproduced below) includes a resource creator line, which was implemented in the metadata (as a label) of the object utilizing the webhook.
apiVersion:apps/v1
metadata:
   resourceVersion:‘148192745’
   name:zen-metastoredb
   labels:
      app: 0010-infra
      app.kubernetes.io/component:zen-metastoredb
      app.kubernetes.io/instance:0010-infra
      app.kubernetes.io/managed-by:0010-infra
      app.kubernetes.io/name:0010-infra
      component:zen-metastoredb
      release:0010-infra
      kubernetes_resource_creator:cp4a-operator

Once these data are available (e.g., as metadata in a label), a user interface accessing the object can read these data and display it. For example, a UI could provide a visual of the creator of the resource given the pod that is being viewed through the UI by a user.

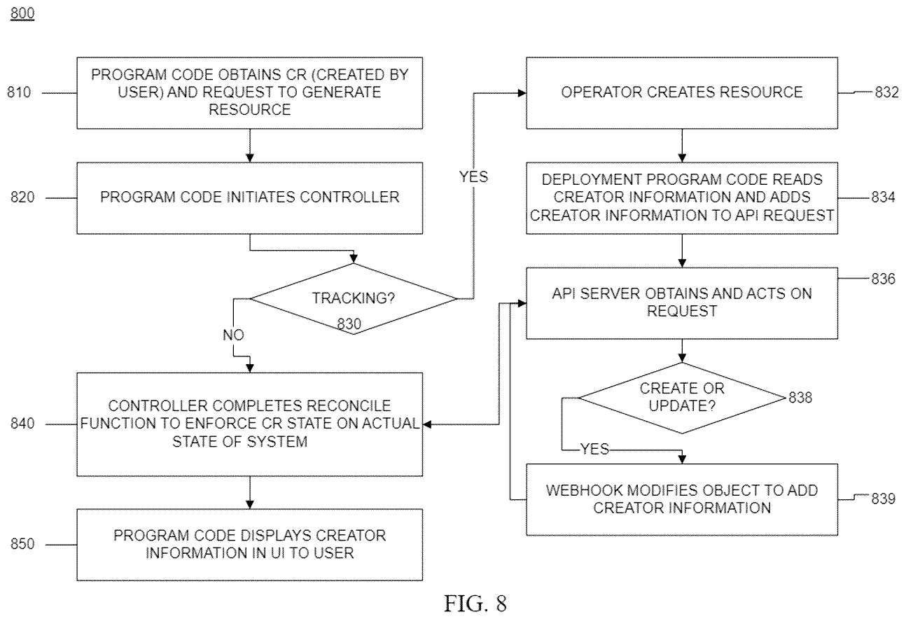

FIG. 8 is a workflow 800 that illustrates various aspect of some examples herein. In this example, a user (e.g., process, tenant, etc.) program code obtains a CR created by a user and a request to generate a resource (810). When a user creates a CR in this type of environment (e.g., Kubernetes), the user is creating a new custom resource object within their cluster, which is made possible by first defining a Custom Resource Definition (CRD) that specifies the structure and properties of this new resource type, allowing them to manage custom data and functionality beyond the standard objects like pods and deployments so that the user can extend the Kubernetes API to fit the user's specific needs. Creating the CR will trigger custom logic through a controller and hence, as illustrated in FIG. 8, the program code (e.g., of an API), initiates a controller (820). The program code determines if tracking is enabled (830). If tracking is not enabled, the program code completes a reconcile function or an equivalent to enforce the CR state on the actual state of the system (840), and the program code displays creator information to a user via a UI (850). In this situation, the creator of the resource is apparent. When tracking is enabled, the aspects of the present examples can be implemented. As illustrated in FIG. 8, program code comprising an operator creates the resource requested (832). The program code that deploys the resource (e.g., SDK) reads the creator information and adds this information to a request to an API server and sends the updated request to the API server (this updated request includes the creator information) (834). The program code of the API server obtains the request and determines whether to implement a create or an update action (responsive to the request) (838). If the request is a create or an update action, the program code of the API server performs an admissions review of the request and implements a mutating admission webhook to implement creator information (839). The enhanced request is sent to the program code responsible for deploying the resource (836). Thus, the resource is deployed by the program code (e.g., the API server) (836) with information related to the creator at the client and at the server. The controller completes a reconcile function (840) and the program code can be displayed to an end user in a UI (850).

The examples herein automate various elements that assist in the administration and business continuity of a SaaS environment. In these examples, the program code automatically adds a creator to each resource which eliminates manual efforts. The relationship chain is clearly defined through the addition of creator information. Also, various aspects of the examples herein as user friendly because a UI can provide a customer with an easy method by which to determine who created various resources, including by utilizing a hyperlink in a web interface.

Although various embodiments are described above, these are only examples. For example, different types of platforms, protocols, interfaces, add-ons, etc. may use and/or benefit from one or more aspects of the present invention. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating operator management in a multiple tenant environment, the computer-implemented method comprising:
obtaining, by one or more processors, based on a user creating a custom resource, a request to generate a resource;
utilizing, by the one or more processors, an operator to create the resource;
enhancing, by the one or more processors, the resource, wherein the enhancing comprises:
appending, by the one or more processors, information identifying a creator of the resource to an application programming interface (API) request to deploy the resource;
based on the enhancing, mutating, by the one or more processors, an object definition of the resource to add the information identifying the creator of the resource to the object definition of the resource; and
deploying, by the one or more processors, the resource with the mutated object definition.

2. The computer-implemented method of claim 1, wherein appending the information identifying the creator of the resource to the API request comprises:
reading, by the one or more processors, an environment variable of a given computing node of the user; and
generating, by the one or more processors, an options variable based on the environment variable.

3. The computer-implemented method of claim 2, wherein the environment variable comprises an operator deployment name.

4. The computer-implemented method of claim 3, wherein the deploying the resource comprises deploying the resource with the operator deployment name.

5. The computer-implemented method of claim 1, wherein mutating the object definition of the resource comprises:
obtaining, by the one or more processors, at an API handler of an API server, the API request with the appended information;
authenticating, by the one or more processors, at the API server, the API request;
utilizing, by the one or more processors, a webhook to mutate the object definition; and
persisting, by the one or more processors, the mutated object definition to a key value store.

6. The computer-implemented method of claim 5, wherein deploying the resource with the mutated object definition comprises utilizing the key value store.

7. The computer-implemented method of claim 1, further comprising:
enforcing, by the one or more processors, a custom resource (CR) state of the resource.

8. The computer-implemented method of claim 7, further comprising:
displaying, by the one or more processors, the information identifying the creator of the resource in a user interface.

9. The computer-implemented method of claim 1, further comprising:
determining, by the one or more processors, that an unexpected event occurred involving the resource;
accessing, by the one or more processors, the information identifying the creator of the resource; and
troubleshooting, by the one or more processors, the unexpected event, wherein the troubleshooting comprises querying the creator.

10. The computer-implemented method of claim 1, further comprising:
continuously tracking, by the one or more processors, the request to generate the resource.

11. A computer system for facilitating operator management in a multiple tenant environment, the computer system comprising:
a memory; and
a node in communication with the memory, wherein the computer system is configured to perform a method, said method comprising:
obtaining, by one or more processors, based on a user creating a custom resource, a request to generate a resource;
utilizing, by the one or more processors, an operator to create the resource;
enhancing, by the one or more processors, the resource, wherein the enhancing comprises:
appending, by the one or more processors, information identifying a creator of the resource to an API request to deploy the resource;
based on the enhancing, mutating, by the one or more processors, an object definition of the resource to add the information identifying the creator of the resource to the object definition of the resource; and
deploying, by the one or more processors, the resource with the mutated object definition.

12. The computer system of claim 11, wherein appending the information identifying the creator of the resource to the API request comprises:
reading, by the one or more processors, an environment variable of a given computing node of the user; and
generating, by the one or more processors, an options variable based on the environment variable.

13. The computer system of claim 12, wherein the environment variable comprises an operator deployment name.

14. The computer system of claim 13, wherein the deploying the resource comprises deploying the resource with the operator deployment name.

15. The computer system of claim 11, wherein mutating the object definition of the resource comprises:
obtaining, by the one or more processors, at an API handler of an API server, the API request with the appended information;
authenticating, by the one or more processors, at the API server, the API request;
utilizing, by the one or more processors, a webhook to mutate the object definition; and
persisting, by the one or more processors, the mutated object definition to a key value store.

16. The computer system of claim 15, wherein deploying the resource with the mutated object definition comprises utilizing the key value store.

17. The computer system of claim 11, further comprising:
enforcing, by the one or more processors, a custom resource (CR) state of the resource.

18. The computer system of claim 17, further comprising:
displaying, by the one or more processors, the information identifying the creator of the resource in a user interface.

19. The computer system of claim 11, further comprising:
determining, by the one or more processors, that an unexpected event occurred involving the resource;
accessing, by the one or more processors, the information identifying the creator of the resource; and
troubleshooting, by the one or more processors, the unexpected event, wherein the troubleshooting comprises querying the creator.

20. A computer program product for facilitating operator management in a multiple tenant environment, the computer program product comprising:
one or more computer readable storage media and program instructions collectively stored on the one or more computer readable storage media to perform a method comprising:
obtaining, based on a user creating a custom resource, a request to generate a resource;
utilizing an operator to create the resource;
enhancing the resource, wherein the enhancing comprises:
appending information identifying a creator of the resource to an API request to deploy the resource;
based on the enhancing, mutating an object definition of the resource to add the information identifying the creator of the resource to the object definition of the resource; and
deploying the resource with the mutated object definition.
